(19) United States
(12) Patent Application Publication
(10) Pub. No.: US 2008/0088061 A1
(43) Pub. Date: Apr. 17, 2008

(54) Cooling Circuit for a Preform Oven and Method of Implementing One Such Circuit

(76) Inventor: Patrick Mie, Octeville sur Mer (FR)

Correspondence Address: YOUNG & THOMPSON, 745 SOUTH 23RD STREET, 2ND FLOOR, ARLINGTON, VA, 22202, US

(21) Appl. No.: 11/628,501

(22) PCT Filed: Jun. 8, 2005
(86) PCT No.: PCT/EP05/52637

§ 371 Date: Feb. 5, 2007

(30) Foreign Application Priority Data
Jun. 15, 2004 (FR) 0451178

(51) Int. Cl. B29C 49/68; B29C 49/00

(52) U.S. Cl. 264/327; 425/526

(57) ABSTRACT

A cooling circuit for a tunnel for heating preforms of the type having two parallel cooling rails, inside which a coolant fluid circulates, a common fluid inlet pipe which is connected to an upstream end of the cooling rails, and a common fluid outlet pipe which is connected to the downstream end of the cooling rails the cooling circuit including elements for measuring the temperature of the fluid, characterized in that the circuit includes a bypass which connects the common outlet pipe to the common inlet pipe so as to form a loop for recirculation of the coolant fluid in the cooling rails in which the coolant fluid is set in circulation by a fluid pump. A method for implementing the cooling circuit is also disclosed.

The invention relates to a cooling circuit for a tunnel for heating preforms.

More particularly, the invention relates to a cooling circuit for a tunnel for heating preforms of the type comprising a parallel first and second cooling rail, inside which rails a coolant fluid circulates and which rails border a longitudinal opening of the heating tunnel, along which the preforms are displaced, of the type comprising a common inlet pipe which is supplied with cold coolant fluid and is connected in parallel to an upstream end of each cooling rail, and comprising a common outlet pipe for the hot coolant fluid which is connected in parallel to the downstream end of each cooling rail, of the type comprising a valve for replacement of the coolant fluid which is connected in one of the common inlet or outlet pipes, the cooling circuit comprising means for measuring the temperature of the coolant fluid, of the type comprising a bypass, the upstream end of which is connected to the common outlet pipe and the downstream end of which is connected to the common inlet pipe so as to form a closed loop for recirculation of the coolant fluid in the cooling rails when the replacement valve is closed, and of the type in which the recirculation loop comprises a fluid pump for making the coolant fluid circulate in the recirculation loop, the cooling circuit comprising means for automatically regulating the temperature of the coolant fluid which comprise an electronic control unit which controls the opening of the replacement valve as a function of operating parameters of the cooling circuit, and in particular as a function of the measured temperature of the coolant fluid in the recirculation loop.

The manufacture of receptacles, and in particular of bottles, made of thermoplastic material, for example of polyethylene terephthalate (PET), is generally carried out starting from previously injection-moulded preforms which are shaped into bottles by an operation of blowing or drawing and blowing of their body and their bottom. The preforms generally have the shape of a test tube, the neck of which already has the final shape of the neck of the bottle. The neck comprises a thread intended to receive a screw cap, for example.

Before carrying out the blowing operation, it is necessary to reheat a first part of each preform, comprising the body and the bottom, to a temperature higher than the vitreous transition temperature of the thermoplastic material in a heating furnace in order to soften the constituent plastic material.

For this purpose, heating furnaces for preforms of the type which comprises a longitudinal heating tunnel are already known. The cold preform with vertical axis is transported by a transport device from a first end of the tunnel, and then it moves along the tunnel in which the first part of the preform, comprising the body and the bottom, is heated before coming out via the second end of the tunnel. The preform thus reheated is ready for the blowing operation.

The heating furnace may comprise one or more heating modules or units which each comprise a tunnel portion and are aligned following one another so as to form a single tunnel of great length. In the rest of the description, the term heating module will be assimilated into the term furnace.

Furthermore, one tunnel wall is equipped with radiation heating means while the other wall is provided with ventilation openings to allow the passage of blown air in order to promote homogeneous heating throughout the thickness of the cylindrical wall of the body of the preform. This is because the blown air makes it possible to remove the convection heat caused by the heating means in order to promote penetration of the radiation to which they give rise into the thickness of the thermoplastic material constituting the body.

In order to ensure in-depth heating of the bottom and of the cylindrical wall of the body of the preform over its entire periphery, the preforms are generally set in rotation about themselves during their movement in the furnace.

However, the neck of the preform, which is shaped to its final shape and dimensions during manufacture, generally by injection-moulding of the preform, must not be deformed during the heating and/or blowing operations. It is therefore essential to keep the neck at a temperature lower than the vitreous transition temperature or softening temperature. For this purpose, the neck of the preform is kept outside the tunnel through an opening of the tunnel which forms a longitudinal passage channel.

In many installations, the preforms are arranged neck down during at least part of their heating. This makes it possible to prevent or to limit reheating of the neck by ascending convection movements of the hot air.

It is known to arrange lateral cooling rails which border the longitudinal opening in order to prevent the heat produced by the heating means heating the neck of the preform by conduction, by convection or by radiation.

A cold coolant fluid circulates inside the cooling rails in order to protect the neck of the preforms effectively from the heat of the heating tunnel. The cooling rails are thus connected in a cooling circuit. The cold coolant fluid supply is controlled by means of a valve for replacement of the fluid.

In a known manner, the fluid replacement valve is opened so as to fill the cooling rails with cold coolant fluid.

Then, when the fluid replacement valve is closed, the coolant fluid remains stagnant in the cooling rails. A probe for measuring the temperature makes it possible to monitor the temperature of the coolant fluid contained in the cooling rails at a point of the cooling circuit.

When the coolant fluid becomes too hot for the neck of the preforms to be protected effectively, the fluid replacement valve is opened and the hot coolant fluid is replaced with cold coolant fluid.

However, the heating means are likely to heat the coolant fluid more rapidly in certain sections of the heating tunnel. This is because, as a function of various parameters such as the final shape of the bottles or the shape of the preforms, the heating means are capable of being regulated to heat the preforms differently according to their position in the tunnel.

The coolant fluid is thus not heated in a homogeneous manner in the cooling rails. The temperature measured at a single point of the cooling circuit is therefore not always representative of the local heating of the coolant fluid at some points of the cooling circuit. In these local points, the cooling rails are likely no longer to protect the neck of the preforms effectively from the heat.

Furthermore, when the coolant fluid which supplies the cooling circuit is too cold, air heated by the furnace is likely to condense on the cooling rails. The condensation may also affect the homogeneity of the heating of the body of the preform.

In order to solve these problems, the invention proposes a cooling circuit of the type described above, characterized in that the regulating means comprise means for measuring the flow of the coolant fluid which are connected in the recirculation loop, and the regulating means control the opening of the replacement valve as a function of the measured flow of coolant fluid in the recirculation loop.

According to other features of the invention:
a non-return valve is connected in the bypass;
each cooling rail comprises at least one upstream section and one downstream section, the downstream end of the upstream section of each cooling rail being connected to the upstream end of the downstream section of the other cooling rail.

The invention also proposes a method for implementing the means for regulating the temperature of the cooling circuit, characterized in that it comprises the following steps:
a first step, of activation of the fluid pump, during which the fluid replacement valve is closed and the fluid pump is activated in order to make the coolant fluid circulate in the recirculation loop;
a second step, of temperature control, during which the temperature of the coolant fluid is measured in the recirculation loop by the temperature measurement means, the measured temperature then being compared with an upper temperature threshold;
a third step, of replacement of coolant fluid, which is initiated when the measured temperature is greater than or equal to the upper temperature threshold, during which the coolant fluid replacement valve is opened in order to make a portion of the hot coolant fluid leave the recirculation loop via the common outlet pipe and to replace it with cold coolant fluid entering the recirculation loop by means of the common inlet pipe;
a fourth step, of closing of the replacement valve, which is initiated when the measured temperature reaches a lower temperature threshold, the method then being repeated starting from the second step.

According to other features of the method:
the second step of temperature control comprises an operation for measuring the flow of the coolant fluid by the flow measurement means, the lower and upper temperature thresholds being variable as a function of the measured flow;
the lower and upper temperature thresholds have a normal value when the measured flow is higher than a lower flow threshold and they have a reduced value when the measured flow is lower than or equal to the lower flow threshold.

Other features and advantages of the invention will emerge in the course of reading the detailed description which follows, for the understanding of which reference will be made to the accompanying drawings, in which:

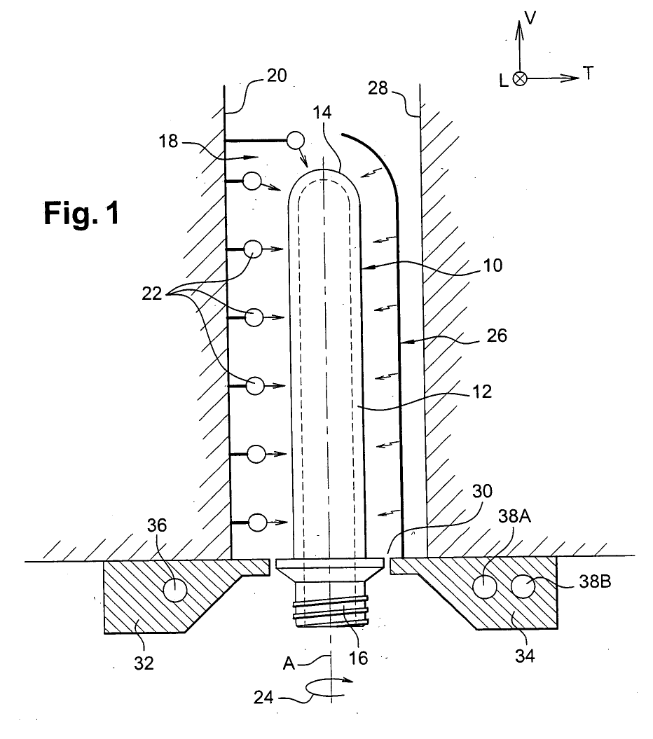

FIG. 1 is a cross-sectional view which shows a heating tunnel inside which the body of a preform is heated, the neck of the preform being kept below the tunnel so as to be protected from the heat by two lateral cooling rails which are supplied with coolant fluid by a cooling circuit;

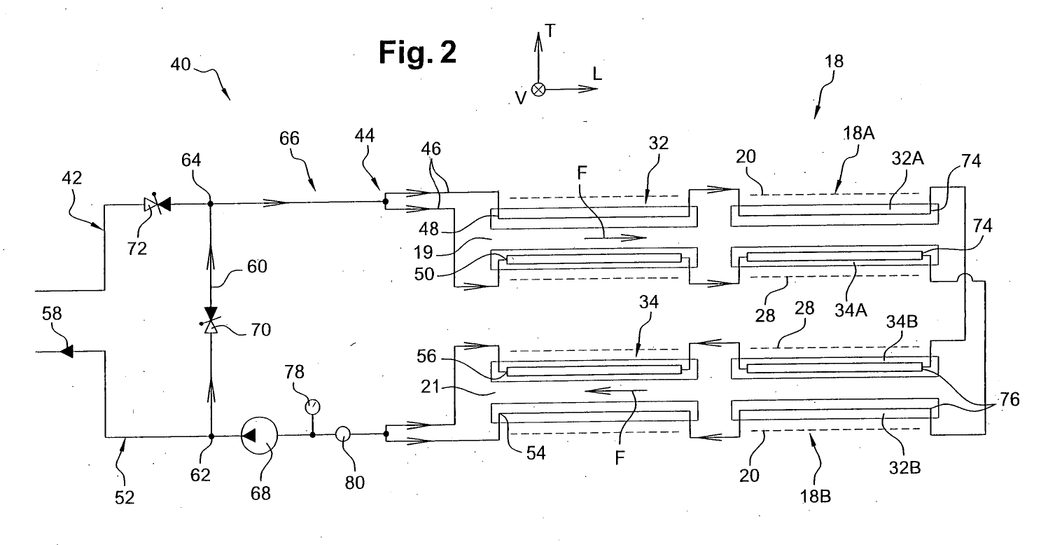

FIG. 2 is a view from above which shows diagrammatically the cooling circuit of the heating tunnel in FIG. 1 which is made according to the invention;

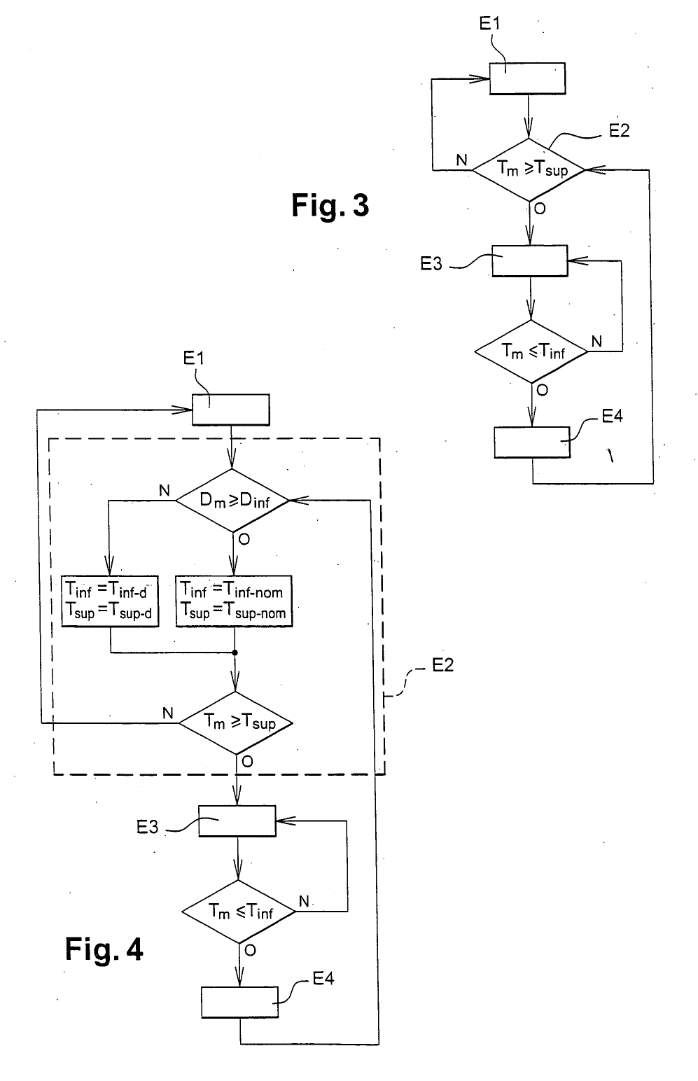

FIG. 3 is a block diagram which shows a method for implementing the cooling circuit in FIG. 2; and

FIG. 4 is a block diagram which shows a variant of the method in FIG. 3.

In the rest of the description, a longitudinal, vertical and transverse orientation indicated by the axis system L, V, T in FIG. 1 will be adopted in a non-limiting way.

A flow direction oriented from upstream to downstream will be adopted for the fluids.

A receptacle preform 10, obtained by injection-moulding for example, which has an essentially cylindrical body of revolution 12 with a vertical axis A with a thick wall, has been illustrated in FIG. 1. A first end, here the upper end, of the preform 10 is closed by a hemispherical bottom 14 with a thick wall. The other end, here the lower end, comprises a neck 16 shaped to its final shape and dimensions.

As explained in the introduction, the preliminary heating step consists in heating the body 12 and the bottom 14 of the preform 10, excluding the neck 16, to a temperature higher than the vitreous transition temperature T of the constituent thermoplastic material of the preform 10.

As illustrated in FIG. 1, the heating is carried out by making the preforms 10 pass through a horizontally oriented heating tunnel 18 comprising at least one vertical lateral heating wall 20 which comprises heating means.

As illustrated in FIG. 2, the heating tunnel 18 comprises two parallel longitudinal portions 18A, 18B. The preforms 10 pass successively through the first portion 18A from a proximal inlet end 19 of the tunnel 18 towards a distal end, and then, after a 180° turn, they pass through the second portion 18B in the opposite direction from the distal end towards the proximal outlet end 21 of the tunnel 18, so that the proximal outlet end 21 of the heating tunnel 18 is close to the proximal inlet 19 of the heating tunnel 18.

However, the invention can also be applied to heating tunnels of different shape, for example longitudinal rectilinear tunnels or semi-circular tunnels.

In the example illustrated in FIG. 2, the walls of the heating tunnel are shown as broken lines. The heating wall 20 is arranged on the “external” side of the furnace, visible in this figure to the left of the preforms 10 in relation to their displacement direction indicated by the arrows F.

As illustrated in FIG. 1, the heating means here comprise seven longitudinal heating tubes 22 which are mounted one above another on the heating wall 20. In a known manner, the heating tubes 22 are lamps which emit infra-red rays of a wavelength suitable for heating by radiation the constituent thermoplastic material of the preforms 10.

The heating tubes 22 are preferably mounted so that it is possible to regulate independently the transverse distance of each heating tube 22 in relation to the preforms 10 moving in the tunnel 18.

In a known manner, the heating tunnel 18 is divided into a number of sections in which the heating means are regulated so as to heat to a greater or lesser extent different parts of the body 12 and of the bottom 14 of the preforms 10 in the course of a single pass through the heating tunnel 18.

In particular, a first “penetration” section or zone can be seen, in which the heating tubes 22 are regulated so as to heat the whole of the body 12 and of the bottom 14 of the preforms 10 to a temperature close to its final value, and a second “profile heating” section or zone in which the tubes 22 are regulated independently so as to heat more specifically certain parts of the body 12 or of the bottom 14 of the preforms 10 as a function of the final shape to be given to the receptacles produced from the preforms 10 during the steps following the heating step.

For example, the penetration zone can correspond to the first longitudinal portion 18A of the heating tunnel, and the “profile heating” zone can correspond to the second longitudinal portion 18B of the heating tunnel.

In order to homogenize the heating, the preforms 10 are simultaneously set in rotation about their axis A as indicated by the arrow 24.

A reflecting panel 26 can preferably be arranged on an opposite vertical lateral wall 28 of the heating tunnel 18 facing the heating tubes 22 to reflect towards the bodies 12 of the preforms 10 the fraction of the heating radiation passing between two successive preforms 10. The opposite lateral wall 28 will therefore be referred to as the reflecting wall 28 in the rest of the description.

In order not to heat the neck 16, the heating tunnel 18 comprises a lower longitudinal opening 30 which is delimited laterally by the longitudinal lower edges of the reflecting wall 28. The neck 16 is thus kept outside the heating tunnel 18, below the opening 30, while the body 12 and the bottom 14 of the preform 10 are heated in the heating tunnel 18.

In the embodiment illustrated in FIG. 1, the longitudinal opening 30 is located below the heating tunnel 18, but the invention can also be applied to heating tunnels provided with an upper opening. In the latter configuration, the preforms 10 then pass through vertically, the neck 16 being directed upwards.

The invention can also be applied to heating tunnels of the “endless chain” type (not shown) which comprise a part in which the preforms 10 are reheated neck 16 up and another part in which the preforms 10 are reheated neck 16 down.

Two parallel longitudinal cooling rails 32, 34 are arranged below the heating wall 20 and the reflecting wall 28 so as to border the longitudinal opening 30. Each cooling rail 32, 34 extends transversely as far as the neck 16 of the preforms 10 but without touching them so as to make the lower longitudinal opening 30 more narrow. The cooling rails 32, 34 have the function in particular of thermally protecting the neck 16 from the heat which prevails in the heating tunnel 18.

In a known manner, one or more opening longitudinal cooling pipes 36, 38A, 38B are formed inside the cooling rails 32, 34 so that a cold coolant fluid can circulate in the cooling rails 32, 34 to cool them. The coolant fluid is glycol diluted in water for example.

The cooling rails 32, 34 are made of aluminium, for example, so that the heat produced in the heating tunnel 18 is communicated by conduction to the coolant fluid contained in the cooling pipes 36, 38A, 38B.

The cooling rails 32, 34 are connected to a cooling circuit 40. The cooling circuit 40 of the heating tunnel 18 has been illustrated diagrammatically in FIG. 2.

The first, external cooling rail 32, which is located below the heating wall 20, comprises a single cooling pipe 36 here. The second, internal cooling rail 34, which is located below the reflecting wall 28, comprises two cooling pipes 38A, 38B here.

This is because the first, external cooling rail 32 has to absorb a greater quantity of heat than the second, external cooling rail 34 as it is arranged facing the heating tubes 22.

The cooling circuit 40 comprises a common inlet pipe 42, the downstream end 44 of which comprises branches 46 so as to supply in parallel with coolant fluid the upstream end 48, 50 of each cooling rail 32, 34.

A common coolant fluid outlet pipe 52 is connected to the downstream end 54, 56 of each cooling rail 32, 34 so as to remove the coolant fluid which has become hot.

The cooling circuit 40 also comprises a valve 58 for replacement of the coolant fluid, which is connected in the common outlet pipe 52. Here, this is a solenoid valve.

According to a variant embodiment (not illustrated), the replacement valve 58 is connected in the common inlet pipe 42.

As the heating tunnel 18 comprises two parallel sections, the external cooling rail 32 is divided into two, upstream and downstream, longitudinal sections, which are indicated by references 32A and 32B respectively. Each longitudinal section, upstream 32A and downstream 32B, is arranged on the respective first portion 18A and 18B of the heating tunnel 18.

In the same way, the internal cooling rail 34 is divided into two, upstream and downstream, longitudinal sections, which are indicated by references 34A, 34B respectively.

According to the teachings of the invention, the cooling circuit 40 comprises a bypass 60, an upstream end 62 of which is connected to the common outlet pipe 52, upstream of the replacement valve 58, and the downstream end 64 of which is connected to the common inlet pipe 42. When the replacement valve 58 is closed, the cooling circuit 40 thus comprises a closed recirculation loop 66 for the coolant fluid.

The recirculation loop 66 comprises the bypass 60, the section of the common inlet pipe 42 between the downstream end 64 of the bypass 60 and the upstream ends 48, 50 of the cooling rails 32, 34, the cooling rails 32, 34, and the section of the common outlet pipe 52 between the downstream ends 54, 56 of the cooling rails 32, 34 and the upstream end 62 of the bypass 60.

A fluid pump 68 is connected in the recirculation loop 66 in order to set the coolant fluid in motion, so that it circulates in clockwise direction in the recirculation loop 66 looking at FIG. 2 when the replacement valve 58 is closed. Here, the fluid pump 68 is connected in the common outlet pipe 52, upstream of the upstream end 62 of the bypass 60.

A first non-return valve 70 is connected in the bypass 60 in order to prevent the fluid from turning in the opposite direction, that is to say the anti-clockwise direction, in the recirculation loop 66.

A second non-return valve 72 is connected in the common inlet pipe 42, upstream of the downstream end 64 of the bypass 60, in order to prevent the coolant fluid from being forced back in the opposite direction towards the upstream end of the common inlet pipe 42.

In order to promote rapid homogenization of the temperature of the coolant fluid throughout the recirculation loop 66, the connection pipes of the upstream sections 32A, 34A and the downstream sections 32B, 34B of the cooling rails 32, 34 are transposed. Thus, the downstream end 74 of the upstream section 32A, 34A of each cooling rail 32, 34 is connected to the upstream end 76 of the downstream section of the other cooling rail 34, 32.

In a variant of the invention, it is possible to divide the cooling rails 32, 34 into more than two sections and to transpose the connections between two successive sections in the same way in order to improve further the homogenization of the temperature of the coolant fluid.

The cooling circuit 40 also comprises automatic means for regulating the temperature of the coolant fluid. Here, these regulating means comprise means 78 for measuring the temperature of the coolant fluid, such as a probe, at a point of the recirculation loop 66. Here, the probe is arranged in the common outlet pipe 52.

The regulating means also comprise an electronic control unit (not shown) which is connected electrically to the means 78 for measuring the temperature, to the fluid pump 68 and to the replacement valve 58.

According to the teachings of the invention, the means for regulating the temperature are implemented according to a method for regulating the temperature which will be described below.

As illustrated in FIG. 3, the method for regulating the temperature of the coolant fluid comprises mainly four steps.

During a first step E1 of activation of the fluid pump 68, the fluid replacement valve 58 is closed, or remains in closed position if it was already closed, and the fluid pump 68 is activated in order to make the coolant fluid circulate in the recirculation loop 66.

Taking the downstream end 64 of the bypass 60 as the starting point, the coolant fluid flows into the common inlet pipe 42 in the direction of the upstream end 48, 50 of the cooling rails 32, 34. The coolant fluid is then distributed into each of the cooling rails 32, 34, and then it is removed in the common outlet pipe 52. As the replacement valve 58 is closed, the coolant fluid uses the bypass 60 to return to the starting point.

Then, during a second step E2 of temperature control, the temperature of the coolant fluid is measured in the recirculation loop 66 by means 78 for measuring the temperature.

The measured temperature Tm is then compared with an upper temperature threshold Tsup above which it is considered that the neck 16 of the preform 10 is no longer protected effectively by the cooling rails 32, 34.

As the coolant fluid is in motion in the recirculation loop 66, the temperature Tm measured by the means 78 for measuring the temperature at a point of the recirculation loop 66 is essentially representative of the temperature of the coolant fluid at any point of the recirculation loop 66.

This is because, as the internal cooling rail 34 is more exposed to the infra-red radiation of the heating tubes 22, the temperature of the coolant fluid which flows in it increases faster than in the other, external cooling rail 32. However, when the coolant fluid thus heated passes through the end connections between the two cooling rails 32, 34, it then supplies the external cooling rail 32 which is less hot than the internal cooling rail 34.

The coolant fluid leaving the internal cooling rail 34 and the coolant fluid leaving the external cooling rail 32 to flow into the common outlet pipe 52 are overall at the same temperature. Furthermore, the mixing of the fluids in the common pipes allows total homogenization of the temperature.

When the measured temperature Tm is greater than or equal to the upper temperature threshold Tsup, a third step E3, of replacement of the coolant fluid, is initiated. The valve 58 for replacement of the coolant fluid is then opened in order to make a portion of the hot coolant fluid leave the recirculation loop 66 via the common outlet pipe 52 and to replace it with cold coolant fluid entering the recirculation loop 66 by means of the common inlet pipe 42.

Finally, when the measured temperature Tm reaches a lower temperature threshold Tinf, a fourth step of closing of the replacement valve 58 is initiated.

The lower temperature threshold Tinf corresponds to a temperature below which air is capable of condensing on the cooling rails 32, 34 and of forming water droplets which are detrimental to the heating of the preform 10.

The method is then repeated starting from the second step E2.

The cooling circuit 40 preferably also comprises means 80 for measuring the flow of the coolant fluid, which are connected electrically to the electronic control unit. Here, these means are a flow meter 80. It is thus possible to locate any malfunctioning of the fluid pump 68.

The means for regulating the temperature are then capable of being controlled according to a reduced mode of the method described above, as illustrated in FIG. 4.

To do this, the second step E2, of temperature control, comprises an additional operation of measuring the flow of the coolant fluid by flow measurement means 80.

The lower Tinf and upper Tsup temperature thresholds are then modified as a function of the measured flow Dm.

For example, the lower Tinf and upper Tsup temperature thresholds have a “normal” value Tinf_nom, Tsup_nom when the measured flow Dm is higher than a lower flow threshold Dinf, that is to say when the fluid pump 68 is functional.

When the measured flow Dm is lower than or equal to the lower flow threshold Dinf, that is to say the fluid pump 68 is no longer functioning or is not functioning properly, a reduced value Tinf_d, Tsup_d is assigned to the lower Tinf and upper Tsup temperature thresholds.

This is because the temperature Tm measured by the temperature measurement means 78 is then no longer representative of the temperature of the coolant fluid at any point of the recirculation loop 66. It is therefore necessary to replace the coolant fluid more frequently to prevent it overheating at a point of the recirculation loop 66, in particular in certain zones such as the penetration zone or the “profile heating” zone.

1. Cooling circuit (40) for a tunnel (18) for heating preforms (10) of the type comprising a parallel first cooling rail (32) and second cooling rail (34), inside which rails a coolant fluid circulates and which rails border a longitudinal opening (30) of the heating tunnel (18), along which the preforms (10) are displaced, of the type comprising a common inlet pipe (42) which is supplied with cold coolant fluid and is connected in parallel to an upstream end (48, 50) of each cooling rail (32, 34), and comprising a common outlet pipe (52) for the hot coolant fluid which is connected in parallel to the downstream end (54, 56) of each cooling rail (32, 34), of the type comprising a valve (58) for replacement of the coolant fluid which is connected in one of the common inlet (42) or outlet (52) pipes, the cooling circuit (40) comprising means (78) for measuring the temperature of the coolant fluid, of the type comprising a bypass (60), the upstream end (62) of which is connected to the common outlet pipe (52) and the downstream end (64) of which is connected to the common inlet pipe (42) so as to form a closed loop (66) for recirculation of the coolant fluid in the cooling rails (32, 34) when the replacement valve (58) is closed, and of the type in which the recirculation loop (66) comprises a fluid pump (68) for making the coolant fluid circulate in the recirculation loop (66), the cooling circuit (40) comprising means for automatically regulating the temperature of the coolant fluid which comprise an electronic control unit which controls the opening of the replacement valve (58) as a function of operating parameters of the cooling circuit, and in particular as a function of the measured temperature (Tm) of the coolant fluid in the recirculation loop (66), characterized in that the regulating means comprise means (80) for measuring the flow of the coolant fluid which are connected in the recirculation loop (66), and in that the regulating means control the opening of the replacement valve (58) as a function of the measured flow (Dm) of coolant fluid in the recirculation loop (66).

2. Cooling circuit (40) according to claim 1, characterized in that a non-return valve (70) is connected in the bypass (60).

3. Cooling circuit (40) according to claim 1, of the type in which the second cooling rail (34) has to absorb a greater quantity of heat than the first cooling rail (32), characterized in that each cooling rail (32, 34) comprises at least one upstream section (32A, 32B) and one downstream section (32B, 34B), the downstream end (74) of the upstream section (32A, 34A) of each cooling rail (32, 34) being connected to the upstream end (76) of the downstream section (32B, 34B) of the other cooling rail (32, 34).

4. Method for implementing the means for regulating the temperature of the cooling circuit made according to claim 1 taken in combination, characterized in that it comprises the following steps:
a first step (E1), of activation of the fluid pump (68), during which the fluid replacement valve (58) is closed and the fluid pump (68) is activated in order to make the coolant fluid circulate in the recirculation loop (66);
a second step (E2), of temperature control, during which the temperature of the coolant fluid is measured in the recirculation loop (66) by the temperature measurement means (78), the measured temperature (Tm) then being compared with an upper temperature threshold (Tsup);
a third step (E3), of replacement of coolant fluid, which is initiated when the measured temperature (Tm) is greater than or equal to the upper temperature threshold (Tsup), during which the coolant fluid replacement valve (58) is opened in order to make a portion of the hot coolant fluid leave the recirculation loop (66) via the common outlet pipe (52) and to replace it with cold coolant fluid entering the recirculation loop (66) by means of the common inlet pipe (42);
a fourth step (E4), of closing of the replacement valve (58), which is initiated when the measured temperature (Tm) reaches a lower temperature threshold (Tinf), the method then being repeated starting from the second step (E2).

5. Method according to claim 4, characterized in that the second step (E2), of temperature control, comprises an operation for measuring the flow of the coolant fluid by the flow measurement means (80), the lower (Tinf) and upper (Tsup) temperature thresholds being variable as a function of the measured flow (Dm).

6. Method according to claim 5, characterized in that the lower (Tinf) and upper (Tsup) temperature thresholds have a normal value (Tinf_nom, Tsup_nom) when the measured flow (Dm) is higher than a lower flow threshold (Dinf) and they have a reduced value (Tinf_d, Tsup_d) when the measured flow (Dm) is lower than or equal to the lower flow threshold (Dinf).

7. Cooling circuit (40) according to claim 2, of the type in which the second cooling rail (34) has to absorb a greater quantity of heat than the first cooling rail (32), characterized in that each cooling rail (32, 34) comprises at least one upstream section (32A, 32B) and one downstream section (32B, 34B), the downstream end (74) of the upstream section (32A, 34A) of each cooling rail (32, 34) being connected to the upstream end (76) of the downstream section (32B, 34B) of the other cooling rail (32, 34).
